(19) United States
(12) Patent Application Publication
(10) Pub. No.: US 2014/0292225 A1
(43) Pub. Date: Oct. 2, 2014

(54) METHOD FOR ADDRESSING LAMP OPERATING DEVICES

(71) Applicants: Kai Arbinger, Hard (AT); Roman Ploner, Hohenems (AT)

(72) Inventors: Kai Arbinger, Hard (AT); Roman Ploner, Hohenems (AT)

(21) Appl. No.: 14/239,107

(22) PCT Filed: Aug. 14, 2012
(86) PCT No.: PCT/AT2012/000212

§ 371 Date: Jun. 13, 2014

(30) Foreign Application Priority Data
Aug. 17, 2011 (AT) GB458/2011

(51) Int. Cl. H05B 37/02

(52) U.S. Cl. CPC H05B 37/0272
USPC 315/294

(57) ABSTRACT

The invention relates to a method for controlling at least one lamp, comprising at least one operating device for operating the lamp, wherein the operating device has a first interface and said interface is connected to a control device and to other operating devices, wherein the operating device operates the lamp according to the control signals received via the first interface, and the operating device has at least one further interface for connection of a sensor, in particular a brightness sensor, and a configuration element, which is connected to the further interface of one operating device and which transmits configuration information to the operating device, wherein the configuration information contains address information and the configuration element produces the address information on the basis of a received radio signal.

### FIELD OF THE INVENTION

The invention relates to a method for actuating illuminant operating units and to a lighting system for actuating at least two illuminants.

### BACKGROUND

Light-control and light-management systems have established themselves as a permanent feature of modern lighting solutions. Illuminant operating units of modern design, such as electronic ballasts for gas discharge lamps or operating units for light emitting diodes, usually have interfaces that can be used to transmit control commands to the operating unit externally. It is thus possible for appropriate control signals to set a desired illumination intensity (dimming level) for the illuminant, for example.

In the lighting industry, various standards for controlling illuminant operating units have been developed that differ from one another in terms of their complexity. The technologically most advanced are digital solutions, wherein the illuminant operating unit has a digital interface that can be used to send digital control commands from a control unit to the illuminant operating unit. The communication in this case can take place bidirectionally, i.e. the illuminant operating unit may not just be a receiver of signal commands, but can also act as a transmitter of signals. By way of example, it is thus possible for the illuminant operating unit to actively feed back a status report to the control unit when an error occurs.

For transmitting the signals, the prior art discloses a wide variety of methods: thus, wired transmission (for example using the power supply line (Powerline) or using a line pair that is separate from the power supply line) and nonwired transmission (for example radio, infrared) are possible.

An example of the control of illuminant operating units that may be referenced is what is known as DSI (Digital Serial Interface) technology and what is known as the DALI (digital addressable lighting interface) protocol. In the DALI standard, an extensive digital control command set is made available for communication with the illuminant operating unit. A DALI-compliant lighting system requires not only the illuminant operating unit with a digital interface but also an associated bus device, including a digital control unit.

In many cases, the user wants a less elaborate technology that is somewhat cheaper but nevertheless provides the essential functionalities. Thus, the prior art also discloses operating units in which either a digital signal or a signal produced by means of a pushbutton switch supplied with mains voltage can be applied to the digital interface (control input).

If the user does not wish to use the digital peripherals, it is optionally possible for the digital control input of the operating unit to be actuated by means of pushbutton switch operation.

In this case, by way of example, the length of time and also the repetition rate for pushbutton switch operation are evaluated as a signal for switching on and/or off or for brightness control (dimming). An example of such an operating unit whose digital control input has a signal generated by means of a pushbutton switch, or switch, supplied with mains voltage applied to it is disclosed in DE 297 24 657, for example.

The stipulation of a dimming scenario with suitable values for the dimming levels, fade-on and fade-off times is found not to be easy in practice, since the switching behavior of the operating unit may be highly dependent on the respective specific application. Thus, in hospital corridors, standards prescribe that a certain residual brightness must always be present even at night, for example, even if no movement has been detected over a certain period of time. By contrast, the lighting on a stairwell in a private residential complex can be switched off relatively quickly at night after ‘calm has set in’ again. The frequency with which movement recognition occurs over time and the length of time between two successive instances of movement recognition may vary considerably: the motion sensor in an underground garage responds very frequently at ‘peak times’ when the underground garage is highly frequented (for example in the morning at the beginning of work and in the evening at the end of work), whereas a movement signal is triggered relatively rarely at calmer times, for example in the dead of night.

Operating units in the prior art have only one dimming scenario; the dimming scenario with the individual dimming parameters is defined during production of the operating unit or during installation shortly before startup, for example by means of programming, and cannot be altered during operation.

It is now necessary for two aspects to be taken into account with priority when setting the dimming scenario: firstly, in order to save as much energy as possible, the illuminants needs to be in operation for as short a time as possible and only when they are actually necessary. Secondly, rapidly successive switch-on and switch-off processes with a short switched-on and switched-off time need to be avoided, since this can have the effect of shortening the life of the illuminant.

### SUMMARY

The object of the invention is to improve the actuation of illuminant operating units. Specifically, the aim is to take account of the requirements of energy efficiency and protection of the illuminant.

Said object of the invention is achieved by the features of the independent claims. The dependent claims develop the central concept in a particularly advantageous manner.

The invention proposes a method for actuating electronically controlled illuminant operating units. This method is used for actuating at least one illuminant, wherein the illuminant is operated by an operating unit, the operating unit is connected via a first interface to a controller and optionally to other operating units, wherein the operating unit operates the illuminant in accordance with the control signals received via the first interface, the operating unit has at least one further interface for connecting a sensor, particularly a brightness sensor, a configuration element that is connected to the further interface of an operating unit and that transmits a piece of configuration information to the operating unit, wherein the configuration information contains a piece of address information and the configuration element produces the address information on the basis of a received radio signal.

Typical examples of such an illuminant operating unit are electronic ballasts (EVG) for gas discharge lamps or operating units for organic or inorganic light emitting diodes.

### BRIEF DESCRIPTION OF THE DRAWINGS

The invention also relates to an operating unit for illuminants that is designed to perform such a method. Further advantages, features and properties of the present invention will now be explained with reference to the appended figure.

FIG. 1 shows an arrangement of an illuminant operating unit with a motion sensor.

FIG. 1 uses a schematic illustration to show a lighting system 10 having a known motion sensor 1, an electronic illuminant operating unit 2 and an illuminant 4 connected to an output 3. In principle, illuminants 4 may be any desired illuminant, for example gas discharge lamps or organic or inorganic light emitting diodes. The illuminant operating unit 2 shown has three connections PE, L, N that can be put into contact with the ground, the phase conductor and the neutral conductor. The operating unit 2 furthermore has a first interface having the connections D1 and D2.

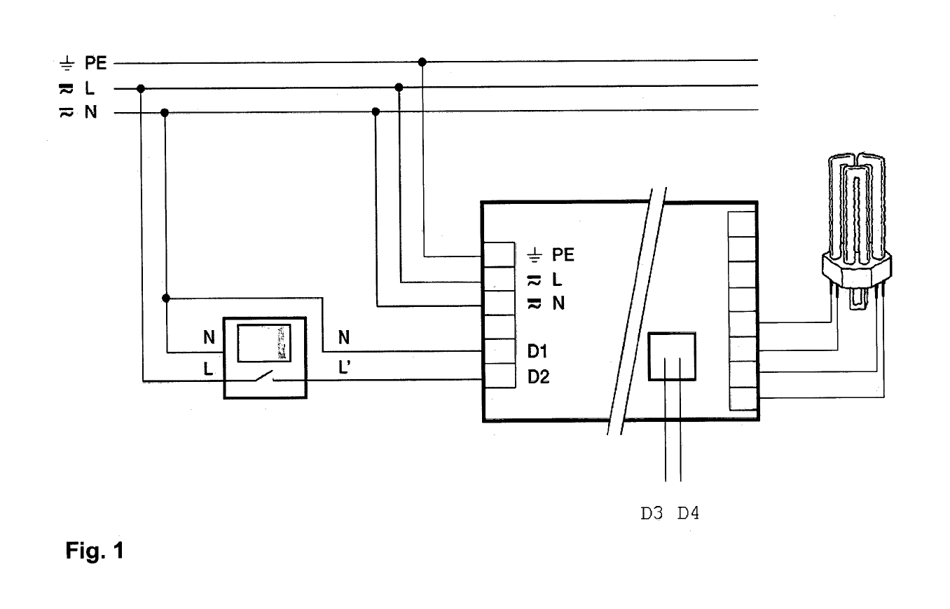

### DETAILED DESCRIPTION OF THE PREFERRED EMBODIMENTS

This interface may be designed such that these connections can be used to send to the operating unit digital commands, for example on the basis of the DALI standard protocol, or the operating unit can send signals. In this case, the operating unit may be connected to a DALI controller via the first interface. Optionally, the two connections D1 and D2 may be embodied such that signals are transmitted by the supply voltage, such as the mains voltage, or else pushbutton switch signals. In the example shown, the connection D1 is connected to the neutral conductor N of the power supply 5. A commercially available motion sensor 1 is connected between the other connection D2 of the operating unit 2 and the phase conductor L of the power supply 5.

The control input D2 may now essentially have two different signals applied to it, namely one for the sensing of a movement by the motion sensor 1 and also a signal that differs from this for when no movement is detected on the motion sensor 1. In the example shown, the following definition is present: if the motion sensor 1 senses a movement, it shorts the connection between the phase conductor L and the connection D2, as a result of which the signal level of the phase conductor L is applied to the control input D2. In the other case, if the motion sensor 1 does not detect a movement, the connection between the phase conductor L and the connection D2 is interrupted, as a result of which no voltage is applied to the connection D2. Naturally, other definitions or codings for the movement signal are possible.

For the evaluation and optimum use of the control signals received via the first interface, it is advantageous if each operating unit can be allocated an address. In this case, it is also possible for a plurality of operating units to have the same address and hence to be combined into groups.

Furthermore, the operating unit 2 has a further interface having the connections D3 and D4. By way of example, this further interface can have a brightness sensor or other sensor, or else could also be used to receive a signal from another operating unit or controller. It may also be possible for this further interface to be used to send signals. The respective use or manner of use of this further interface may be programmable.

This further interface can now have a configuration element connected to it that transmits a piece of configuration information to the operating unit, wherein the configuration information contains a piece of address information and the configuration element produces the address information on the basis of a received radio signal.

The configuration element may have a memory that is preferably nonvolatile and can have information written to it repeatedly.

The further interface can be used to allow unidirectional or bidirectional communication between the operating unit and the configuration element.

The operating unit can be put into an addressing mode via the first interface. The configuration element may have means for recognizing radio signals and the operating unit can receive the address information from the configuration element when the operating unit has been put into the addressing mode and the configuration element recognizes a radio signal.

The configuration element may have means for evaluating radio signals and the operating unit can receive the address information from the configuration element. In this case, the configuration element can evaluate the radio signals so as either to transmit the address information on directly to the operating unit or to produce said address information itself when the operating unit has been put into the addressing mode.

The variant that the configuration element receives the allocation of an address directly from the radio signal (i.e. coded as a data record by means of the radio signal transmission) and evaluates the radio signals in order to transmit the address information on directly to the operating unit affords an advantageous possibility of address allocation, for example for use in the case of systems without a return channel to the controller (that is to say in the case of a unidirectional embodiment of the first interface, such as in the case of digital broadcast actuation, for example DSI, or else pushbutton switch control).

The configuration element may have means for evaluating radio signals and the operating unit can receive the address information from the configuration element. In addition, the configuration element can put the operating unit into an addressing mode and, when the operating unit has been put into the addressing mode, can evaluate the radio signals so as either to transmit the address information on directly to the operating unit or to produce said address information itself.

The configuration element can optionally also send radio signals itself, for example in order to confirm the reception of a radio signal. By way of example, it is thus also possible to confirm the reception of a transmitted address or the allocation of an address. Hence, bidirectional data transmission can also take place by means of radio signals between configuration element and the hand-held transmitter.

The configuration element can additionally receive control information via the radio signal, and can take this control information as a basis for changing the operation of the illuminant in accordance with the freshly captured configuration information.

The radio signals can be transmitted by means of standardized transmission such as WLAN, Bluetooth, Zigbee, GPRS or UMTS. The radio signals can be transmitted by a hand-held transmitter. Such a hand-held transmitter may be in the form of a programming appliance with radio transmission for address allocation or else can be formed by a normal mobile radio, such as a mobile telephone, that has the possibility of transmission using WLAN, Bluetooth, Zigbee, GPRS or UMTS.

The illuminant may be an organic or inorganic LED or a gas discharge lamp (fluorescent lamp, high-pressure gas discharge lamp).

The replacement of an operating unit can involve the address information and also optionally particular operating data being transmitted by means of the configuration element from the operating unit to be replaced to the fresh operating unit to be used.

The further interface can be used by the operating unit to supply power to the configuration element.

Besides the configuration element, a sensor may additionally be connected to the further interface.

Alternatively, the configuration element may be connected to the further interface instead of a sensor.

The configuration element may be distinguished by color.

The operation of the illuminant by the operating unit may additionally take place on the basis of a piece of configuration information that is prescribed by the configuration element.

The configuration element may be connected to the further interface in addition to a sensor or instead of a sensor.

The radio signal can also be produced by means of a hand-held transmitter, as a result of which a passive and hence also inexpensive receiver in the configuration element is sufficient.

The hand-held transmitter can produce a highly oriented radio lobe as a radio signal in order to address as few operating units as possible in the space. In addition, this hand-held transmitter may have a WLAN or mobile radio link to a DALI controller (for example arranged in a switchgear cabinet).

In order to address the operating units as appropriate, the DALI controller can put the operating units into an addressing mode and then the DALI controller can progressively or repeatedly poll all the operating units. If the engineer now points the hand-held transmitter at a lamp with an operating unit, a weak radio signal is emitted and slowly amplified. As soon as a configuration element receives this radio signal as a receiver, this information is forwarded from the configuration element to the operating unit and from the operating unit via the first interface to the DALI controller. In addition, or alternatively, the operating unit can change the brightness of the illuminant. Hence, the lamp or the operating unit is identified and the operating unit can be allocated an address that is also known to the DALI controller. Hence, a radio signal (in this case a hand-held transmitter) can be used to allocate an address to any operating unit.

In addition to the addressing, the operating unit can also change the operation of the illuminant in accordance with a piece of configuration information that is prescribed by the configuration element.

By way of example, the following changes are possible:
a. a change of brightness value in emergency lighting mode
b. locking or unlocking of dimming operation in emergency lighting mode
c. change of control parameters for illuminant operation (rated current, heating power)
d. change of response when connecting sensors to one of the interfaces
e. change or extension of the control signals (command set)
f. update of control software (Firmware) on the operating unit or at least the interface controller of the operating unit
g. change of turn-off thresholds or error-recognition thresholds (e.g. for illuminant operation, an interface or the supply)
h. change of dimming scenarios with suitable values for the dimming stages, fade-on and fade-off times
i. change of individual values for dimming stages, fade-on and fade-off times
j. change of execution response (for example shortening of the preheating time or skipping of the preheating time, shortening of the ignition phase)

The operating unit can also use the freshly captured configuration information to change its functionality.

By way of example, a change of control parameters for illuminant operation can mean that the lamp type to be operated is changed or else that changed operating data are prescribed for the already connected lamp type. By way of example, it is thus possible for the rated current or the heating power (this may relate to the heating current and/or the heating voltage) to change. By way of example, a change of control parameters may alternatively mean that limit values or the reduction response for temperature limiting are adjusted. The change of heating power in preheating mode can also be effected by changing the preheating time (while retaining the transmitted heating power in a particular time window), for example. Alternatively, adjustment of control parameters or of the execution response can also mean increased compatibility with other installed operating units.

By way of example, in the event of a fault, a new operating unit that actually allows more efficient preheating with a shorter preheating time can therefore be used. In order to allow all operating units to be started uniformly and simultaneously, however, the configuration element can be used to allocate to the new operating unit a longer preheating time that corresponds to the preheating time of the already installed operating units. The configuration element can also allow the user, for example a lamp manufacturer, a higher level of flexibility for test measurements, for example. The possible alteration of the execution response or else the change of turn-off thresholds or error-recognition thresholds can allow a faster sequence of test measurements or else a simpler test measurement setup, for example using a substitute load instead of the actual illuminant.

The configuration element may also have a plurality of DIP switches or jumpers for setting configuration information. In this case, it is either possible for the configuration element to read the relevant configuration information from its memory, and transmit it to the operating unit, in accordance with the chosen switch positions of the DIP switches, for example, or else for the operating unit to read the chosen switch positions directly (these could be looped through, for example).

It may also be possible to use the configuration element to read data (operating data) from the operating unit so as then to change said data and to transmit them in changed form back to the operating unit. This can be accomplished using a programming appliance, for example, that can read and change the memory of the configuration element and can write fresh information to it. In this way, a user can make a change on an operating unit without the operating unit needing to be removed or a programming appliance needing to be connected to the operating unit directly. In addition, the configuration element can also be permanently connected to the operating unit.

The configuration element may also be embodied as a male or female connector, for example, that can simultaneously attain a mechanically robust connection to the operating unit (particularly to the housing of the operating unit) and reliable contact-connection to the further interface of the operating unit. The configuration element may also have a connection for a computer interface, for example a USB port, a Firewire port or an eSATA port. If such a connection for a computer interface is existent, the configuration element can easily be connected to a computer by the user, and said computer can read stored data (operating data) from the configuration element, can change stored data or else can transmit stored data from the computer to the configuration element. Hence, simple reading and/or prescribing of data for the configuration element can be rendered possible by means of a computer.

Hence, a method for actuating at least one illuminant is also made possible, wherein the illuminant is operated by an operating unit, the operating unit is connected via a first interface to a controller and to other operating units, wherein the operating unit operates the illuminant in accordance with the control signals received via the first interface, the operating unit has at least one further interface for connecting a sensor, particularly a brightness sensor, a configuration element that is connected to the further interface of an operating unit and that transmits a piece of configuration information to the operating unit, wherein the configuration information contains a piece of address information and the configuration element produces the address information on the basis of a received radio signal.

Hence, a lighting system is also rendered possible, having at least one operating unit for operating the illuminant, wherein the operating unit has a first interface and this interface is connected to a controller and optionally to other operating units, wherein the operating unit operates the illuminant in accordance with the control signals received via the first interface, the operating unit is connected to a configuration element that transmits a piece of configuration information to the operating unit, wherein the configuration information contains a piece of address information and the configuration element produces the address information on the basis of a received radio signal.

In this case, the configuration element may also be arranged in the operating unit and at least receive radio signals.

In summary, the invention discloses improved addressing of an illuminant operating unit that is distinguished in that the address allocation can take place without direct contact or even opening of a lamp.

1. A method for actuating at least one illuminant, the method comprising
operating the at least one illuminant by an operating unit,
connecting the operating unit via a first interface to a controller and optionally to other operating units, wherein the operating unit operates the at least one illuminant in accordance with the control signals received via the first interface,
providing the operating unit with at least one further interface for connecting a sensor, particularly a brightness sensor,
providing a configuration element that is connected to the further interface of an operating unit and that transmits a piece of configuration information to the operating unit,
wherein the configuration information contains a piece of address information and the configuration element produces the address information on the basis of a received radio signal.

2. A lighting system for actuating at least one illuminant, the system comprising:
at least one operating unit for operating the at least one illuminant, wherein the operating unit has a first interface and this interface is connected to a controller and optionally to other operating units,
wherein the operating unit operates the at least one illuminant in accordance with the control signals received via the first interface,
the operating unit has at least one further interface for connecting a sensor, particularly a brightness sensor,
a configuration element that is connected to the at least one further interface of an operating unit and that transmits a piece of configuration information to the operating unit,
wherein the configuration information contains a piece of address information and the configuration element produces the address information on the basis of a received radio signal.

3. The lighting system as claimed in claim 2, wherein the configuration element has a memory that is preferably nonvolatile and can have information written to it repeatedly.

4. The lighting system as claimed in claim 2, wherein the at least one further interface is used to allow unidirectional or bidirectional communication between the operating unit and the configuration element.

5. The lighting system as claimed in claim 2, wherein the operating unit can be put into an addressing mode via the first interface.

6. The lighting system as claimed in claim 5, wherein the configuration element is adapted to receive radio signals and the operating unit receives the address information from the configuration element when the operating unit has been put into the addressing mode and the configuration element recognizes a radio signal.

7. The lighting system as claimed in claim 5, wherein
the configuration element is configured to evaluate radio signals and the operating unit receives the address information from the configuration element,
the configuration element evaluates the radio signals so as either to transmit the address information on directly to the operating unit or to produce said address information itself when the operating unit has been put into the addressing mode.

8. The lighting system as claimed in claim 2, wherein the configuration element is configured to evaluate radio signals and the operating unit receives the address information from the configuration element, the configuration element can put the operating unit into an addressing mode, and, when the operating unit has been put into the addressing mode, evaluates the radio signals so as either to transmit the address information on directly to the operating unit or to produce said address information itself.

9. The lighting system as claimed in claim 8, wherein the configuration element can additionally receive control information via the radio signal, and takes the control information as a basis for changing the operation of the at least one illuminant in accordance with the freshly captured configuration information.

10. The lighting system as claimed in claim 8, wherein the radio signals are transmitted by means of standardized transmission.

11. The lighting system as claimed in claim 2, wherein the at least one illuminant is an organic or inorganic LED or is a gas discharge lamp.

12. The lighting system as claimed in the claim 2, wherein replacement of an operating unit involves particular operating data being transmitted by means of the configuration element from an operating unit to be replaced to a fresh operating unit to be used.

13. The lighting system as claimed in claim 2, wherein the at least one further interface is used by the operating unit to supply power to the configuration element.

14. The lighting system as claimed in claim 2, wherein the configuration element is connected to the at least one further interface in addition to a sensor.

15. The lighting system as claimed in claim 2, wherein the configuration element is connected to the at least one further interface instead of a sensor.

16. The lighting system as claimed in claim 2, wherein the configuration element is distinguished by color.

17. A lighting system for actuating at least one illuminant, comprising:
at least one operating unit for operating the at least one illuminant, wherein the operating unit has a first interface and this interface is connected to a controller and optionally to other operating units,
wherein the operating unit operates the at least one illuminant in accordance with the control signals received via the first interface,
the operating unit is connected to a configuration element that transmits a piece of configuration information to the operating unit,
wherein the configuration information contains a piece of address information and the configuration element produces the address information on the basis of a received radio signal.

18. The lighting system as claimed in claim 17, wherein the operating unit can be put into an addressing mode via the first interface.

19. The lighting system as claimed in claim 18, wherein the configuration element is configured to recognize radio signals and the operating unit receives the address information from the configuration element when the operating unit has been put into the addressing mode and the configuration element recognizes a radio signal.
